(19) United States
(12) Patent Application Publication
(10) Pub. No.: US 2026/0239456 A1
(43) Pub. Date: Aug. 13, 2026

(54) HANDLING OF DOWNLINK VERSUS UPLINK COLLISION

(71) Applicant: Nokia Technologies Oy, Espoo (FI)

(72) Inventors: Nhat-Quang NHAN, Massy (FR); Youngsoo YUK, Seoul (KR); Jing Yuan SUN, Beijing (CN); Claudio ROSA, Aalborg (DK); Matha DEGHEL, Massy (FR); Guillermo POCOVI, Aalborg (DK); Erika PORTELA LOPES DE ALMEIDA, Aalborg (DK)

(21) Appl. No.: 19/153,763

(22) PCT Filed: Feb. 17, 2023
(86) PCT No.: PCT/CN2023/076958

§ 371 Date: Aug. 5, 2025

(51) Int. Cl. H04W 74/0833

(52) U.S. Cl. CPC H04W 74/0858

(57) ABSTRACT

Embodiments of the present disclosure relate to method for handling of downlink versus uplink collision. A terminal device determines a collision between an uplink transmission and a downlink transmission scheduled in a slot; determines a scheme for resolving the collision, wherein the scheme indicates whether one of the uplink transmission and the downlink transmission is to be entirely or partially dropped; and performs, based on the scheme, at least one of transmitting the uplink transmission or receiving the downlink transmission. The solution enables determining and handling collision between DL and UL transmission in a slot.

### FIELD

Various example embodiments relate to the field of telecommunication and in particular, to devices, methods, apparatuses and a computer readable storage medium for handling of downlink versus uplink collision.

### BACKGROUND

In the communications area, there is a constant evolution ongoing in order to provide efficient and reliable solutions for utilizing wireless communication networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

One of the objectives of the study item of 3GPP is to allow simultaneous DL and UL transmission on different physical resource blocks (PRBs)/subbands within an unpaired wideband NR cell, and this may be referred to this as subband non-overlapping full duplex (SBFD). In SBFD slots, there are non-overlapping DL (downlink) subbands and UL (uplink) subband(s) both exist. In SBFD operation, with the appearance of both UL and DL subbands in SBFD slots, there exists the potential collision between DL and UL transmissions.

### SUMMARY

In general, example embodiments of the present disclosure provide a solution for handling of downlink versus uplink collision, for example, in sub-band full duplex operation.

In a first aspect, there is provided a terminal device. The terminal device comprises at least one processor and at least one memory storing instructions. The instructions, when executed by the at least one processor, cause the terminal device at least to: determine, a collision between an uplink transmission and a downlink transmission scheduled in a slot; determine a scheme for resolving the collision, wherein the scheme indicates whether one of the uplink transmission and the downlink transmission is to be entirely or partially dropped; and perform, based on the scheme, at least one of transmitting the uplink transmission or receiving the downlink transmission.

In a second aspect, there is provided a network device. The network device comprises at least one processor; and at least one memory storing instructions. The instructions, when executed by the at least one processor, cause the access network device at least to: transmit, to a terminal device, a configured time length for the terminal device to determine a collision between an uplink transmission and a downlink transmission scheduled in a slot; and transmit, to the terminal device, an indication that whether one of the uplink transmission and the downlink transmission is to be entirely or partially dropped.

In a third aspect, there is provided a method. The method comprises determining, at a terminal device, a collision between an uplink transmission and a downlink transmission scheduled in a slot; determining a scheme for resolving the collision, wherein the scheme indicates whether one of the uplink transmission and the downlink transmission is to be entirely or partially dropped; and performing, based on the scheme, at least one of transmitting the uplink transmission or receiving the downlink transmission.

In a fourth aspect, there is provided a method. The method comprises transmitting, at a network device and to a terminal device, a configured time length for the terminal device to determine a collision between an uplink transmission and a downlink transmission scheduled in a slot; and transmitting, to the terminal device, an indication that whether one of the uplink transmission and the downlink transmission is to be entirely or partially dropped.

In a fifth aspect, there is provided an apparatus. The apparatus comprises means for determining, at a terminal device, a collision between an uplink transmission and a downlink transmission scheduled in a slot; means for determining a scheme for resolving the collision, wherein the scheme indicates whether one of the uplink transmission and the downlink transmission is to be entirely or partially dropped; and means for performing, based on the scheme, at least one of transmitting the uplink transmission or receiving the downlink transmission.

In a sixth aspect, there is provided an apparatus. The apparatus comprises means for transmitting, at a network device and to a terminal device, a configured time length for the terminal device to determine a collision between an uplink transmission and a downlink transmission scheduled in a slot; and means for transmitting, to the terminal device, an indication that whether one of the uplink transmission and the downlink transmission is to be entirely or partially dropped.

In a seventh aspect, there is provided a non-transitory computer readable medium comprising program instructions for causing an apparatus to perform at least the method according to any one of the above third to fourth aspect.

In an eighth aspect, there is provided a non-transitory computer readable medium comprising program instructions stored thereon for performing at least the method according to any one of the above third to fourth aspect.

In a ninth aspect, there is provided a computer program comprising instructions, which, when executed by an apparatus, cause the apparatus at least to: determine a collision between an uplink transmission and a downlink transmission scheduled in a slot; determine a scheme for resolving the collision, wherein the scheme indicates whether one of the uplink transmission and the downlink transmission is to be entirely or partially dropped; and perform, based on the scheme, at least one of transmitting the uplink transmission or receiving the downlink transmission.

In a tenth aspect, there is provided a computer program comprising instructions, which, when executed by an apparatus, cause the apparatus at least to: transmit, to a terminal device, a configured time length for the terminal device to determine a collision between an uplink transmission and a downlink transmission scheduled in a slot; and transmit, to the terminal device, an indication that whether one of the uplink transmission and the downlink transmission is to be entirely or partially dropped.

In an eleventh aspect, there is provided a terminal device comprising: a first determining circuitry configured to determine a collision between an uplink transmission and a downlink transmission scheduled in a slot; a second determining circuitry configured to determine a scheme for resolving the collision, wherein the scheme indicates whether one of the uplink transmission and the downlink transmission is to be entirely or partially dropped; and performing circuitry configured to perform, based on the scheme, at least one of transmitting the uplink transmission or receiving the downlink transmission.

In a twelfth aspect, there is provided a network device comprising: a transmitting circuitry configured to transmit, to a terminal device, a configured time length for the terminal device to determine a collision between an uplink transmission and a downlink transmission scheduled in a slot; and transmit, to the terminal device, an indication that whether one of the uplink transmission and the downlink transmission is to be entirely or partially dropped.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication system in which embodiments of the present disclosure may be implemented;

FIG. 1B illustrates a schematic diagram illustrating SBFD and non-SBFD slots;

FIG. 1C illustrates a schematic diagram illustrating frequency-time resource partitioning with SBFD as compared to FDD and TDD;

FIG. 2 illustrates a schematic diagram illustrating a process of communication between a terminal device and a network device according to some embodiments of the present disclosure;

FIG. 3 illustrates a schematic diagram illustrating a process of communication between a terminal device and a network device according to some other embodiments of the present disclosure;

FIG. 4 illustrates a flow chart of a method at a terminal device according to some embodiments of the present disclosure;

FIG. 5 illustrates an example of DL versus UL transmissions collision due to timeline unsatisfied according to some embodiments of the present disclosure;

FIG. 6 illustrates an example of a way for handling a collision between a DL transmission and a UL transmission according to some embodiments of the present disclosure;

FIG. 7 illustrates another example of a way for handling a collision between a DL transmission and a UL transmission according to some embodiments of the present disclosure;

FIG. 8 illustrates a way for a terminal device to determine a scheme for resolving a collision between a DL transmission and an UL transmission according to some embodiments of the present disclosure;

FIG. 9 illustrates a way for a terminal device to determine a scheme for resolving a collision between a DL transmission and an UL transmission according to some other embodiments of the present disclosure;

FIG. 10 illustrates a schematic diagram illustrating a method implemented at a terminal device according to some embodiments of the present disclosure;

FIG. 11 illustrates a schematic diagram illustrating a method implemented at a network device according to some embodiments of the present disclosure;

FIG. 12 illustrates a simplified block diagram of an apparatus that is suitable for implementing embodiments of the present disclosure; and

FIG. 13 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

3GPP 5G NR currently supports two duplexing modes: FDD for paired bands and TDD for unpaired bands. In TDD, the time domain resource is split between downlink and uplink. Allocation of a limited time duration for the uplink in TDD would result in reduced coverage, increased latency, and reduced capacity. Motivated by this, 3GPP has agreed to initiate a Rel-18 study item (RP-213591) on the evolution of duplexing operation in NR that addresses the challenges above. One of the objectives of the study item is to allow simultaneous DL and UL transmission on different physical resource blocks (PRBs)/subbands within an unpaired wideband NR cell. This may be referred to as subband non-overlapping full duplex (SBFD). This duplexing scheme may be also referred to as cross division duplexing (xDD) scheme or flexible division duplexing (FDU).

Some of the objectives of the study item (RP-213591) in the study item description is as follows:

In this study, the followings are assumed:

| | |
|---|---|
| • | Duplex enhancement at the gNB side |
| • | Half duplex operation at the UE side |
| • | No restriction on frequency ranges |

The detailed objectives are as follows:

| • | ( . . . ) | |
|---|---|---|
| • | Study the subband non-overlapping full duplex and potential enhancements on | |
| | dynamic/flexible TDD (RAN1, RAN4). | |
| | - | Identify possible schemes and evaluate their feasibility and performances |
| | | (RAN1). |
| | - | Study inter-gNB and inter-UE CLI handling and identify solutions to manage |
| | | them (RAN1). |

| | |
|---|---|
| [symbol] | Consider intra-subband CLI and inter-subband CLI in case of the |
| | subband non-overlapping full duplex. |

| | |
|---|---|
| - | Study the performance of the identified schemes as well as the impact on |
| | legacy operation assuming their co-existence in co-channel and adjacent |
| | channels (RAN1). |
| - | Study the feasibility of and impact on RF requirements considering |
| | adjacent-channel co-existence with the legacy operation (RAN4). |
| - | Study the feasibility of and impact on RF requirements considering the |
| | self-interference, the inter-subband CLI, and the inter-operator CLI at gNB |
| | and the inter-subband CLI and inter-operator CLI at UE (RAN4). |

( . . . )

From the above description of SBFD operation, it can be observed that there are two slot types for both DL and UL transmissions, namely: SBFD slots, during which the non-overlapping DL subbands and UL subband(s) both exist, and Non-SBFD slots, during which the entire band is used for either DL or UL (i.e., legacy/full DL/UL slots).

Several SBFD operation modes have been studied including whether time and frequency locations of subbands for SBFD operation are known to the SBFD-aware UE or not. It however has been agreed in 3GPP RAN1 #110 meeting that at least the operation mode with time and frequency locations of subbands for SBFD operation being known to the SBFD-aware UE is prioritized. This means that SBFD slots should be known by the (SBFD-aware) UE in one way or another.

In RAN1 #110b meeting, the following agreement was made:

Agreement

Identify if there are any cases of time domain conflict of UE's UL
and DL operation in the same SBFD symbol for SBFD aware UE
If there are, whether/how to avoid/handle such collision cases (as
second step)

In SBFD operation, with the appearance of both UL and DL subbands in SBFD slots, there exists the potential collision between DL and UL transmissions. Depending on whether a UL/DL transmission is dynamically scheduled or semi-statically configured via RRC signalling, the collision can be classified into the following scenarios:

Scenario 1: Dynamic DL transmission vs. dynamic UL transmission.

Scenario 2: Semi-static DL transmission vs. dynamic UL transmission.

Scenario 3: Dynamic DL transmission vs. semi-static UL transmission.

Scenario 4: Semi-static DL transmission vs. semi-static UL transmission.

The above Scenario 1 can be considered as an error case since NW would not dynamically schedule two transmissions to be collided. In contrast, Scenarios 2-4 are valid given that at least one of the transmissions is semi-statically configured. This provides flexibility for the scheduler, given that it may be challenging to always avoid the semi-statically configured resources. Since the motivation of introducing SBFD operation is to improve UL performance and latency, it is straightforward that dynamic UL transmission should be prioritized in Scenario 2, at least in case the UL and DL transmissions have the same priority level, assuming that the UL is dynamically scheduled for critical UL traffic and the network (NW) is aware of the traffic in the semi-statically configured DL resources. Collision handlings for Scenarios 3 and 4 are not straightforward (especially when priority index is considered) and will be proposed in the present disclosure.

Rel-15 and Rel-16 specified different rules for handling collision between UL transmissions. Specifically, Rel-16 URLLC feature introduced different priority indices, namely high priority (HP) and low priority (LP), to handle the collisions between URLLC (HP) and other (LP) transmissions. Although the priority index was introduced for URLLC application, specification does not preclude using the feature for other applications. UE determines whether a UL resource is HP or LP as follows:

For DG PUSCH, the priority index is indicated by priority indicator field in DCI format 0_X if the higher layer parameter priorityIndicatorDCI-0-X is configured.

For CG PUSCH, the priority index is RRC configured by phy-PriorityIndex in ConfiguredGrantConfig.

For PUSCH with semi-persistent CSI report, the priority index is provided by priority indicator field, if provided, in the DCI format that activates the SP CSI report.

For PUCCH: For scheduling request (SR), the priority index is RRC configured by phy-PriorityIndex in SchedulingRequestResourceConfig and indicates whether the PUCCH resource for SR is HP or LP. For HARQ-ACK, specifically, for HARQ-ACK of DG PDSCH, the priority index of the PUCCH resource for HARQ-ACK is indicated by priority indicator field in the DCI that schedules the associated PDSCH, and for HARQ-ACK of PDSCH with semi-persistent scheduling (SPS) or SPS release, the priority index is provided by harq-CodebookID in SPS-Config, if provided.

For the new collision type (i.e., between DL and UL transmissions) introduced in the context of SBFD, the following issues exist:

Issue 1: Priority index of DL channel. In some technical schemes, for dynamic PDSCH, priority indicator field in a DL DCI scheduling a PDSCH indicates priority index of the corresponding PUCCH resource for reporting HARQ-ACK of the PDSCH but not priority index of the PDSCH itself, given that PDSCH did not need priority index (no DL vs. UL collision allowed in the past). Similarly, for SPS PDSCH, the priority index configured in harq-CodebookID also does not indicate priority index of the PDSCH. One approach is to apply the priority index indicated for HARQ-ACK as priority index also for the corresponding PDSCH. Always using priority index of HARQ-ACK for PDSCH would imply that handling of collision between the PDSCH and other UL channels should follow the priority index (i.e., HP channel is prioritized). However, for some scenarios and applications, NW may want to always prioritize UL transmissions in SBFD slot or prioritize dynamically scheduled channels, regardless of the priority index of PDSCH and the UL transmissions (while the priority index is still used for handling collisions between HARQ-ACK of the PDSCH and other UL transmissions). Therefore, means for NW to indicate to UE whether the priority index of HARQ-ACK should be applied for the corresponding PDSCH or not should be specified.

Issue 2: DL versus UL collision determination. In some technical schemes that do not involve SBFD operation, for the UL versus UL transmissions collision handling, it is straightforward for UE to determine whether there is collision or not by determining whether there is at least one overlapping symbol between the two transmissions. This is not always the case for determining whether DL and UL transmissions are collided or not in SBFD operation. First, given that UE needs time for switching from reception to transmission, then even if DL and UL transmissions are not collided, but if the UL transmission comes after the DL transmission and does not satisfy certain timeline for Rx to Tx switching, then the two transmissions should also be considered as collided. This DL versus UL collision determination rule should be specified. Second, there might be cases in which the resources are semi-statically configured for a UL transmission, but there is no data to transmit in a given occasion. In case there is an overlap of a scheduled DL transmission and the resources reserved for a CG-PUSCH, if the UE has no data to transmit, the UE should prioritize the DL reception, even when the CG-PUSCH has higher priority.

Issue 3: Collision handling for the case when both DL and UL transmissions are HP. Assuming now that priority index for PDSCH is indicated by NW (i.e., Issue 1 is solved) and UE is able to determine whether there is collision between DL and UL in SBFD slots (i.e., Issue 2 is solved), then the following cases may happen:

Case 1: DL and UL transmissions are associated with different priority indices.

Case 2: Both DL and UL transmissions are associated with LP.

Case 3: Both DL and UL transmissions are associated with HP.

For Case 1, it is straightforward that transmissions with higher priority index is prioritized. For Case 2, some simple rules such as always prioritizing UL transmissions or prioritizing dynamically scheduled transmissions, as proposed in some solutions, can be applied (given that both transmissions are LP). In contrast, the handling of Case 3 is not straightforward given that both transmissions are HP. It is worth noting that, in Rel-16, the case both transmissions are HP for UL versus UL collision can be handled by multiplexing the two transmissions, which cannot be applied for handling DL versus UL collision.

Considering an example in which DL transmission is dynamic HP PDSCH and UL transmission is semi-static HP PUCCH with SR, one potential solution is to always prioritize the dynamically scheduled channel (i.e., HP PDSCH). Another potential solution is to partially cancel/drop the earlier transmitted channel following certain timeline conditions. The following issues can be identified: The timeline conditions for partial cancelling/dropping do not exist for DL versus UL collision. Only NW knows whether the HP PDSCH is much more critical than HP SR or not, in other words, only NW knows whether UE should drop HP SR or partially drop HP PDSCH. Therefore, means for NW to indicate which solution to be applied by UE (fully dropping or partially dropping/cancelling) should be specified. The need of partial dropping is even more relevant considering the new collision type introduced in Issue 2. Dynamic HP PDSCH can be scheduled to avoid collision with semi-static SR, however, it's worth noting that NW does not know whether UE would send something in the SR occasion or not. Therefore, it's very restrictive to always assume that scheduler should always avoid semi-static resources.

In summary, some documents focus on identifying the scenarios to be studied for the new DL vs. UL collision. Some documents proposed simple solutions for the related scenarios, namely: UEs do not expect to be scheduled with such collision, dynamically scheduled transmissions always have higher priority, or uplink transmissions always have higher priority. Partial dropping of the collided resources or conditional dropping were not mentioned in any document. No document disclose handling rule incase DL and UL transmissions are associated with priority index. This present disclosure proposes a method for handling the collision between DL and UL transmissions in a slot (for example a SBFD slot) to solve the problems above.

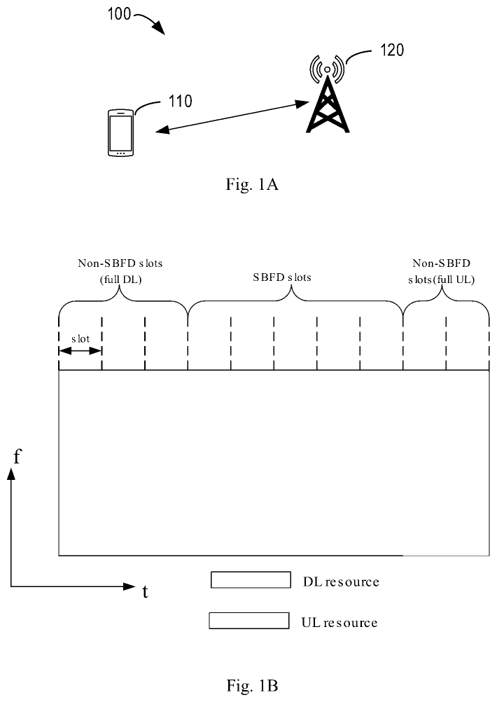

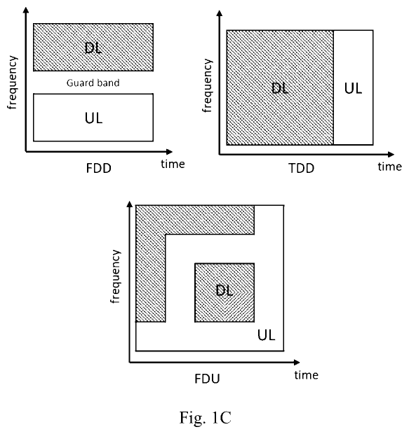

Principles and embodiments of the present disclosure will be described in detail below with reference to the accompanying drawings. Reference is first made to FIG. 1A, which illustrates an example communication system 100 in which embodiments of the present disclosure may be implemented. The system 100 includes terminal device 110 and network device 120. The terminal device 110 is capable of connecting and communicating in an UL or DL with the network device 120 as long as the terminal device 110 located within the corresponding cells. In communication systems, an UL refers to a link in a direction from a terminal device 110 to a network device 120, and a DL refers to a link in a direction from the network device 120 to the terminal device 110. The network device 120 may transmit scheduling information scheduling an uplink transmission to the terminal device 110, and the terminal device 110 may transmit a plurality of repetitions of the uplink transmission to the network device 120.

It is to be understood that the number of network devices 120 and terminal devices 110 is only for the purpose of illustration without suggesting any limitations. The system 100 may include any suitable number of network devices 120 and terminal devices 110 adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Based on what has been discussed above, some contents will be further described below with reference to the accompanying drawings. FIG. 1B illustrates a schematic diagram illustrating SBFD and non-SBFD slots. During the SBFD slots the non-overlapping DL subbands and UL subband(s) both exist, and, during the non-SBFD slots the entire band is used for DL or UL (i.e., legacy/full DL/UL slots). FIG. 1C illustrates a schematic diagram illustrating frequency-time resource partitioning with SBFD as compared to FDD and TDD.

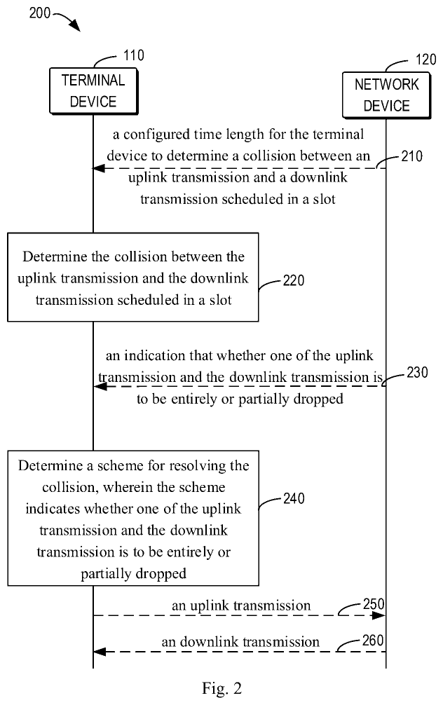

FIG. 2 illustrates a schematic diagram illustrating a process 200 of communication between the terminal device 110 and the network device 120 according to some embodiments of the present disclosure. As shown in FIG. 2, the network device 120 may transmit (210), to the terminal device 110, a configured time length for the terminal device 110 to determine a collision between an uplink transmission and a downlink transmission scheduled in a slot. On the terminal device 110 side, the terminal device 110 may determine (220) the collision between the uplink transmission and the downlink transmission scheduled in a slot. The network device 120 may transmit (230) an indication that whether one of the uplink transmission and the downlink transmission is to be entirely or partially dropped. The terminal device 110 may determine (240) a scheme for resolving the collision, in which the scheme indicates whether one of the uplink transmission and the downlink transmission is to be entirely or partially dropped. In some embodiments, an uplink transmission between the terminal device 110 and the network device 120 may be performed (250) based on the scheme. For example, the terminal device 110 may transmit and the network device 120 may receive the uplink transmission based on the scheme. In some embodiments, a downlink transmission between the terminal device 110 and the network device 120 may be performed (260) based on the scheme. For example, the network device 120 may transmit and the terminal device 110 may receive the downlink transmission based on the scheme.

In some embodiments, the configured time length may be a first configured time length starting from the last symbol of the downlink transmission. Additionally, or alternatively, in some embodiments, the configured time length may be a second configured time length starting from the last symbol of the uplink transmission.

In some embodiments, in order to determine the collision, the terminal device 110 may determine that the uplink transmission starts later than a last symbol of the downlink transmission but earlier than an end of the first configured time length starting from the last symbol of the downlink transmission. In some other embodiments, in order to determine the collision, the terminal device 110 may determine that the downlink transmission starts later than a last symbol of the uplink transmission but earlier than an end the second configured time length starting from the last symbol of the uplink transmission. In some other embodiments, in order to determine the collision, the terminal device 110 may determine that the uplink transmission and the downlink transmission have at least one overlapping symbol. In some embodiments, the terminal device 110 may determine the collision by combining one or more of the embodiments described above.

As mentioned above, the network device 120 may transmit (210), to the terminal device 110, the configured time length. On the terminal device 110 side, the terminal device 110 may receive the configured time length from the network device 120. In some other embodiments, the configured time length may be a hardcoded value stored in the terminal device 110. That is, the first configured time length or the second configured time length or both of them may be a hardcoded value stored in the terminal device 110, additionally, or alternatively, indicated by a network device 120.

In some embodiments, the network device 120 may transmit, to the terminal device 110, a first indication that priority information for an uplink resource corresponding to the downlink transmission indicates a priority of the downlink transmission. On the terminal device 110, the terminal device 110 may receive, from the network device 120, the first indication. The indication in the step 230 may be referred to as a second indication.

In some embodiments, the priority information for the uplink resource is first priority information, and in order to determine the scheme for resolving the collision, the terminal device 110 may be based on second priority information for the uplink transmission and the first priority information, determine that priorities of the uplink transmission and the downlink transmission are the same; and determine the scheme for resolving the collision based on the second indication indicating whether one of the uplink transmission and the downlink transmission is to be entirely or partially dropped.

In some embodiments, the terminal device 110 may receive the second indication from the network device 120. In some other embodiments, the second indication may be comprised in scheduling information for scheduling the downlink transmission, additionally, or alternatively, the second indication may be comprised in a radio resource control (RRC) signaling. In some other embodiments, the second indication may be hardcoded information in the terminal device 110.

In some embodiments, the second indication may comprise a set of starting symbols of the downlink transmission in a slot corresponding to an option of partially dropping or entirely dropping of the downlink transmission, additionally, or alternatively, a set of resource blocks of the downlink transmission in frequency domain corresponding to an option of the partially dropping or the entirely dropping, additionally, or alternatively, a length of the partial dropping, additionally, or alternatively, a plurality of options of length of the partial dropping and information for selecting one of the plurality of options.

In some embodiments, the second indication is indicative of the downlink transmission is to be entirely dropped, additionally, or alternatively, the uplink transmission is to be entirely dropped in the event that there is no data to transmit in the uplink transmission or in case of negative scheduling request, additionally, or alternatively, the uplink transmission is to be entirely dropped; or additionally, or alternatively, the downlink transmission is to be partially dropped.

In some embodiments, the second indication uses at least one of a time domain resource allocation (TDRA), a modulation and coding scheme (MCS), a RNTI, or a frequency domain resource allocation (FDRA) to indicate: a priority of the downlink transmission with respect to overlapping UL transmission, additionally, or alternatively, entirely dropping of the uplink transmission, partially dropping of the downlink transmission, entirely dropping of the downlink transmission.

In some embodiments, the scheme for resolving the collision may comprise: based on the second indication that the downlink transmission is to be partially dropped, determining a starting symbol from which the downlink transmission is to be partially dropped based on the first configured time length starting from the last symbol of the downlink transmission; and in the event that a condition to partially drop the downlink transmission is satisfied, partially dropping the downlink transmission starting from the starting symbol.

In some embodiments, the starting symbol may be at the first configured time length duration before the starting of the uplink transmission. In some embodiments, the scheme for resolving the collision may comprise: in the event that the condition to partially drop the downlink transmission is not satisfied, entirely dropping the downlink transmission. In some embodiments, the network device 120 may indicate a third configured time length for the terminal device 110 to determine the scheme for resolving the collision. In some other embodiments, the third configured time length may be a hardcoded value stored in the terminal device 110.

In some embodiments, in order to determine that the condition is satisfied, the terminal device 110 may determine that the condition is satisfied in the event that the duration from the last symbol of scheduling information for scheduling the downlink transmission to the starting symbol is not less than the third configured time length.

In some other embodiments, in order to determine that the condition is satisfied, the terminal device 110 may determine that the condition is satisfied in the event that the duration from the last symbol of scheduling information for scheduling the downlink transmission to the first symbol where the collision occurs is less than the third configured time length.

In some embodiments, the scheme for resolving the collision may comprise entirely dropping the downlink transmission based on: the downlink transmission is to be partially dropped being not indicated, additionally, or alternatively, the downlink transmission is to be entirely dropped being indicated.

In some embodiments, on the network device 120 side, the network device 120 may perform the same operations as the steps 220 and 240 on the terminal device 110 side. That is, the terminal device 110 may also determine the collision and the scheme for resolving the collision. For example, in some embodiments, the network device 120 may determine the collision by determining that the uplink transmission starts later than a last symbol of the downlink transmission but earlier than an end of the configured time length starting from the last symbol of the downlink transmission, additionally, or additionally, by determining that the downlink transmission starts later than a last symbol of the uplink transmission but earlier than an end a second configured time length starting from the last symbol of the uplink transmission, additionally, or additionally, by determining that the uplink transmission and the downlink transmission have at least one overlapping symbol. In some embodiments, the network device 120 may determine the scheme for resolving the collision by: based on second priority information for the uplink transmission and the first priority information, determine that priorities of the uplink transmission and the downlink transmission are the same; and determine the scheme for resolving the collision based on a second indication indicating whether one of the uplink transmission and the downlink transmission is to be entirely or partially dropped. Other similar operations on the network side can refer to terminal device 110 side and will not be described in detail.

According to some embodiments of the present disclosure, a method for handling collision between the DL and UL transmissions in SBFD slots is proposed. The DL (such as PDSCH) and UL transmissions (such as PUCCH (at least in case of positive SR), CG PUSCH, or configured PUSCH or PUSCH repetition, SRS) are associated with the same priority (e.g., high priority).

In some embodiments, the terminal device 110 may determine whether the priority index of HARQ-ACK should be applied for the corresponding PDSCH or not. The terminal device 110 may determine whether a DL transmission and a UL transmission are collided in SBFD slot(s) or not based, at least partially, on a first timeline that is hardcoded in specification or configured by NW. The first timeline is an example of the first configured time length.

In some embodiments, the terminal device 110 may determine whether one of the overlapping channels should be entirely dropped or if a channel can be partially dropped based on an implicit indication from NW, for entire dropping or dropping length of the partial dropping, where the partial dropping length can be one repetition of multiple repetitions, one or multiple symbol, one or multiple samples (e.g. half CP), etc.

In some embodiments, the terminal device 110 may determine whether one of the overlapping channels should be entirely dropped or if a channel can be partially dropped based on a second timeline (in case DL transmission is dynamic PDSCH). In some embodiments, separate timeline is defined/configured for entire dropping and partial dropping. In some embodiments, the second timelines can also be defined for different length of partial dropping. The second timeline is an example of the third configured time length.

In some embodiments, the terminal device 110 may determine whether one of the overlapping channels should be entirely dropped or if a channel can be partially dropped based on whether there is UL data to transmit in a CG-PUSCH. In some embodiments, in case there is no data to transmit in the UL grant, the terminal device 110 can override the implicit indication from NW and always prioritize the DL reception.

In some embodiments, the terminal device 110 may determine whether one of the overlapping channels should be entirely dropped or if a channel can be partially dropped based on whether UCI is (to be) multiplexed on CG-PUSCH or on PUSCH repetition. In some embodiments, in case there is no UCI to multiplex on PUSCH (and/or there is no data to transmit in the PUSCH), the terminal device 110 can override the implicit indication from NW and always prioritize the DL reception.

In some embodiments, the terminal device 110 may determine whether one of the overlapping channels should be entirely dropped or if a channel can be partially dropped based on whether, in case of PUCCH, SR is positive or negative or whether the PUCCH contains positive or negative SR. In some embodiments, for example, in case of negative SR, the UE can override the implicit indication from NW and always prioritize the DL reception. In some embodiments, the terminal device 110 may determine a symbol from which a channel should be partially dropped based, at least partially, on the first timeline.

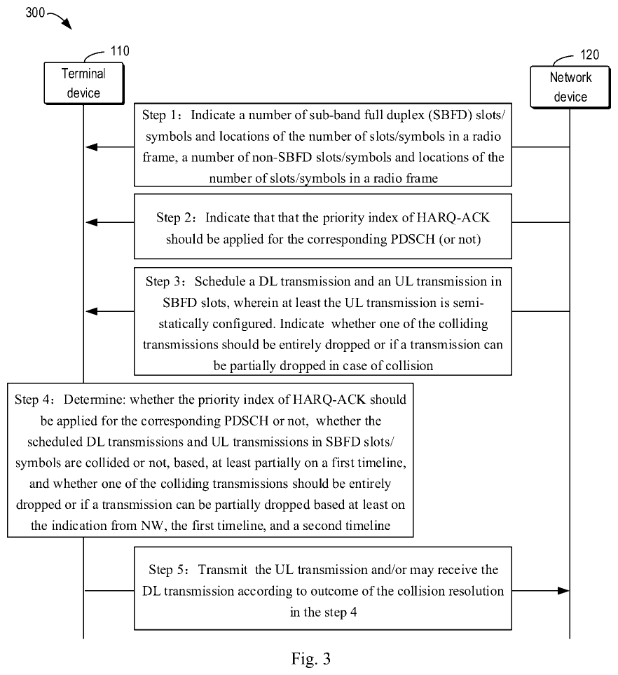

FIG. 3 illustrates a schematic diagram illustrating a process 300 of communication between the terminal device 110 and the network device 120 according to some other embodiments of the present disclosure. It is to be understood that the process 300 can be considered as a more specific example of the process 200. As shown in FIG. 3, as an example, the process 300 may comprise step 1 to step 5. It is noted that the order of step 1 and step 2 may be interchangeable or mergeable. As an example, the terminal device 110 may be UE, and the network device 120 may be referred as NW for short.

In step 1, the network device 120 may indicate, and the terminal device 110 may receive a frequency band, a number of slots/symbols in which the frequency band is split into multiple subbands and in which at least one subband is used for DL (downlink) transmissions and at least one subband is used for UL (uplink) transmissions, i.e., sub-band full duplex (SBFD) slots/symbols, and locations of the number of slots/symbols in a radio frame, and a number of slots/symbols in which the entire frequency band is used for the DL transmissions or the UL transmissions, i.e., non-SBFD slots/symbols, and locations of the number of slots/symbols in a radio frame.

In step 2, the network device 120 may indicate, and the terminal device 110 may receive (e.g., via RRC) an indication that the priority index of HARQ-ACK should be applied for the corresponding PDSCH (or not). The indication in the step 2 is an example of the first indication mentioned above.

In some embodiments, the PDSCH is an example of the downlink transmission. In some embodiments, the priority index of HARQ-ACK is an example of the priority information for an uplink resource corresponding to the downlink transmission. In some embodiments, a PUCCH resource for reporting the HARQ-ACK of the PDSCH is an example of the uplink resource.

In step 3, the network device 120 may schedule the DL transmission and the UL transmission with the same priority in SBFD slots, in which at least the UL transmission is semi-statically configured (e.g., the DL transmission is dynamic PDSCH, and the UL transmission is semi-static PUCCH with SR).

The network device 120 may indicate (additionally, or alternatively configure for) the terminal device 110 whether one of the colliding transmissions should be entirely dropped or if a transmission can be partially dropped in case of collision. In some embodiments, for example, in the step 3, the network device 120 may transmit an indication to the terminal device 110 to indicate the terminal device 110 whether one of the colliding transmissions should be entirely dropped or if a transmission can be partially dropped in case of collision. The indication in the step 3 is an example of the second indication mentioned above.

For example, in some embodiments, the network device 120 may implicitly indicate to entirely drop or partially drop the DL transmission based on its resource allocation following at least one of the approaches below.

In some embodiments, the network device 120 may configure a set of starting symbols in a slot in which the DL transmission is associated with the option of entire dropping, and another set of starting symbols in a slot in which DL transmission is associated with the option of partial dropping. In some other embodiments, the set of starting symbols and the another set of starting symbols may be hardcoded in specification, that is, may be hardcoded information in the terminal device 110.

In some embodiments, the network device 120 may configure a set of resource blocks in frequency domain in which the DL transmission is associated with the option of entire dropping, and another set of resource blocks in frequency domain in which the DL transmission is associated with the option of partial dropping. In some other embodiments, the set of resource blocks in frequency domain and the another set of resource blocks in frequency domain may be hardcoded in specification, that is, may be hardcoded information in the terminal device 110.

In some embodiments, the length of partial dropping can also be indicated, and multiple dropping length according to different condition can be indicated separately. In some embodiments, one way is semi-statically configured options of dropping length and implicitly indicate which dropping length by dynamic signalling/indication.

In some embodiments, the indication by the network device 120 could be explicit, e.g., configured via RRC or indicated in the DCI scheduling PDSCH using an additional field. In some embodiments, the additional field may indicate always dropping the DL transmission. Additionally, the additional field may indicate always drop the DL transmission, unless there is no data to transmit in UL or in case of negative SR. Additionally, the additional field may indicate always drop the UL transmission. Additionally, the additional field may indicate always partially drop the DL transmission (if specific conditions are met, for example a second timeline condition. The second timeline condition will be described in detail below.)

In some embodiments, the indication (i.e. the second indication) by the network device 120 could be explicit, e.g., configured via RRC and indicated in the DCI scheduling PDSCH using existing field(s), such as using/through TDRA (time domain resource allocation), MCS (modulation and coding scheme) or FDRA (frequency domain resource allocation). In some embodiments, for example, a new column may be added to the TDRA table to indicate whether for each TDRA entry whether this entry is associated with priority of PDSCH with respect to overlapping the UL transmission, additionally or alternatively associated with drop the UL transmission, additionally or alternatively associated with partially drop PDSCH, additionally or alternatively associated with entirely drop PDSCH.

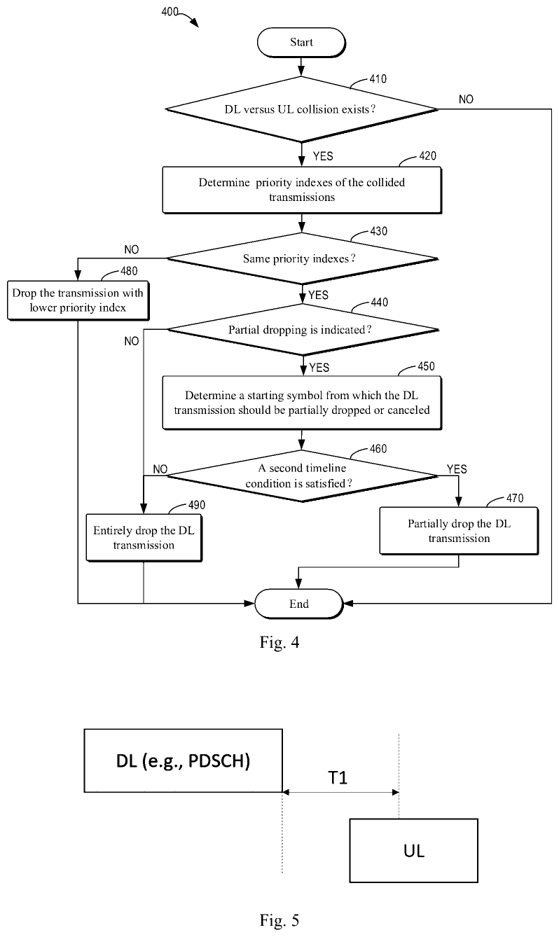

Step 4 may be described below with reference to FIG. 4. FIG. 4 illustrates a flow chart of a method 400 at the terminal device 110 according to some embodiments of the present disclosure. In the step 4, the flow chart of a method 400 performed by the terminal device 110 comprises: the terminal device 110 may determine (410) whether a collision between the DL transmission versus the UL transmission exists. In some embodiments, the collision may be determined based on a first timeline condition (will described below in details).

If the collision exists, the terminal device 110 may determine (420) priority indexes of the collided transmissions.

In some embodiments, a priority index of the downlink transmission may be priority information for an uplink resource corresponding to the downlink transmission which used for indicating the priority of the downlink transmission. In some embodiments, the downlink transmission may be PDSCH, and the priority index of the downlink transmission may be the priority index of HARQ-ACK applied for the PDSCH.

In some embodiments, a priority index of the uplink transmission (an example of the second priority information mentioned above) may be determined by one of a plurality of ways. For example, as mentioned above, for DG PUSCH, the priority index is indicated by priority indicator field in DCI format 0_X if the higher layer parameter priorityIndicatorDCI-0-X is configured. For CG PUSCH, the priority index is RRC configured by phy-PriorityIndex in ConfiguredGrantConfig. For PUSCH with semi-persistent CSI report, the priority index is provided by priority indicator field, if provided, in the DCI format that activates the SP CSI report. For PUCCH: For scheduling request (SR), the priority index is RRC configured by phy-PriorityIndex in SchedulingRequestResourceConfig and indicates whether the PUCCH resource for SR is HP or LP. For HARQ-ACK, For HARQ-ACK of DG PDSCH, the priority index of the PUCCH resource for HARQ-ACK is indicated by priority indicator field in the DCI that schedules the associated PDSCH. For HARQ-ACK of PDSCH with semi-persistent scheduling (SPS) or SPS release, the priority index is provided by harq-CodebookID in SPS-Config, if provided.

After determining the priority indexes of the collided transmissions, the terminal device 110 may determine (430) whether the collided transmissions have the same priority indexes. In some embodiments, the terminal device 110 may determine whether the priorities of the uplink transmission and the downlink transmission both corresponding to HP or LP.

If the collided transmissions have the same priority indexes, the terminal device 110 may determine (440) whether partial dropping is indicated, for example the terminal device 110 may determine whether the partial dropping of the downlink transmission is indicated or not. In some embodiments, the partial dropping may be indicated by the network device 120.

If the partial dropping of the downlink transmission is indicated, the terminal device 110 may determine (450) a starting symbol from which the DL transmission should be partially dropped or canceled. Then the terminal device 110 may determine (460) whether a second timeline condition is satisfied. In some embodiments, the starting symbol may be at the first timeline duration before the starting of the UL transmission.

If the second timeline condition is satisfied, the terminal device 110 may partially drop (470) the DL transmission.

As to the step 430, if the collided transmissions do not have the same priority indexes, the terminal device 110 may drop (480) the transmission with lower priority index.

As to the step 440, if the partial dropping of the downlink transmission is not indicated, the terminal device 110 may entirely drop (490) the downlink transmission.

As to the step 460, if the second timeline condition is not satisfied, the terminal device 110 may entirely drop (490) the downlink transmission.

With continued reference to FIG. 4, the flow on the terminal device 110 side (mainly the step 4 of FIG. 3) will be described in further detail below.

In the step 4 of FIG. 3, the terminal device 110 may determine whether the priority index of HARQ-ACK should be applied for the corresponding PDSCH or not (in case DL transmission is dynamic or semi-persistent PDSCH) based on the indication from the network device 120.

In some embodiments, the terminal device 110 may determine whether the scheduled DL transmissions and UL transmissions in SBFD slots/symbols are collided or not, based, at least partially, on a first timeline that is hardcoded in specification or indicated by the network device 120. In some embodiments, the first timeline is an example of the first configured time length.

In some embodiments, the DL and UL transmissions are considered to be collided if the DL and UL transmissions overlap in time domain.

In some other embodiments, the DL and UL transmissions are considered to be collided if the UL transmission starts later than last symbol of the DL transmission but earlier than the end of the first timeline, which starts from last symbol of the DL transmission. With reference to FIG. 5, T1 denotes the first timeline, and PDSCH is an example of the DL transmission. As shown in FIG. 5, the UL transmission starts later than last symbol of the DL transmission but earlier than the end of the first timeline, so there is a collision between the uplink transmission and the downlink transmission scheduled in a slot.

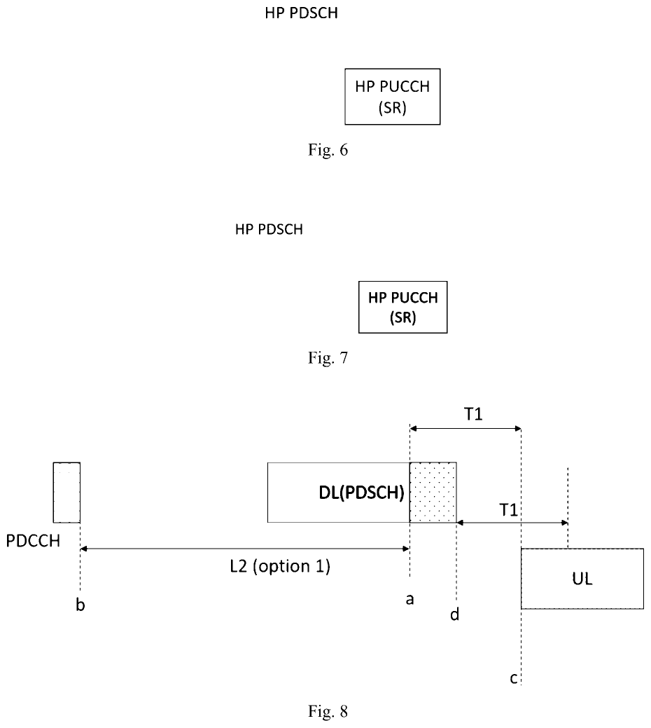

In some embodiments, the terminal device 110 may determine whether one of the colliding transmissions should be entirely dropped or if a transmission can be partially dropped based at least on the indication from NW, the first timeline, and a second timeline, which is hardcoded in specification or indicated by NW. For example, the downlink transmission is PDSCH, and the uplink transmission is PUCCH, as shown in FIG. 6 and FIG. 7, two ways for handling the collision between the DL transmission and the UL transmission are shown. One way for handling the collision is dropping HP SR, as shown in FIG. 6. The other way for handling the collision is partially dropping HP PDSCH, as shown in FIG. 7, the white part in FIG. 7 of the HP PDSCH is partially dropped.

In step 5 of FIG. 3, the terminal device 110 may transmit the UL transmission and/or may receive the DL transmission according to outcome of the collision resolution in the step 4. The collision resolution may be referred to as the scheme for resolving the collision herein. The collision resolution may further refer to the steps of FIG. 4, for example, the steps 470, 480, and 490, etc.

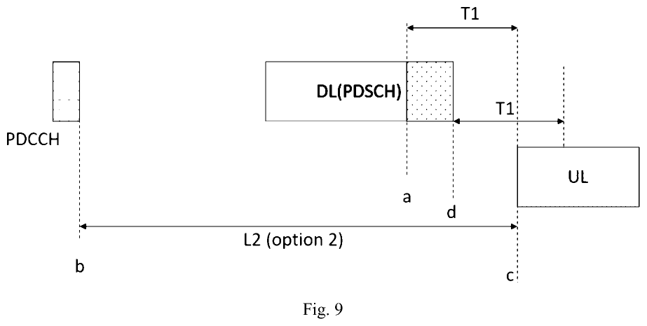

In some embodiments, for example, if the duration from the last symbol of the PDCCH that schedules the DL transmission (e.g., dynamic PDSCH) to the determined starting symbol from which the DL transmission should be partially dropped (option 1) or, alternatively, to the first symbol where the collisions between the DL transmission and the UL transmission occurs (Option 2) is less than the second timeline, the terminal device 110 entirely drops the DL transmission. Else, the terminal device 110 partially drops the DL transmission starting from the determined starting symbol from which the DL transmission should be partially dropped. With reference to FIG. 8, FIG. 8 illustrates a way for the terminal device 110 to determine the scheme for resolving the collision between the DL transmission and the UL transmission, and FIG. 8 corresponds to the option 1 above. With reference to FIG. 9, FIG. 9 illustrates another way for the terminal device 110 to determine the scheme for resolving the collision between the DL transmission and the UL transmission, and FIG. 9 corresponds to the option 2 above. In FIG. 8 and FIG. 9, T1 denotes the first timeline. In FIG. 8, L2 (from point b to a) denotes the duration from the last symbol of the PDCCH that schedules the DL transmission (e.g., dynamic PDSCH) to the determined starting symbol from which the DL transmission should be partially dropped. In FIG. 9, L2 (from point b to c) denotes the duration from the last symbol of the PDCCH that schedules the DL transmission (e.g., dynamic PDSCH) to the first symbol where the collisions between the DL transmission and the UL transmission occurs. The part corresponding to point a to d of the PDSCH is the part of the DL transmission should be partially dropped.

In some embodiments, as mentioned above, the step 4 of FIG. 3 above may be performed on the network side. That is, the network device 120 may also determine the collision and the collision resolution. In some embodiments, for example, once the network device 120 determines the collision resolution that the downlink transmission is partially or entirely dropped, then the network device 120 may partially or entirely cancel the downlink transmission.

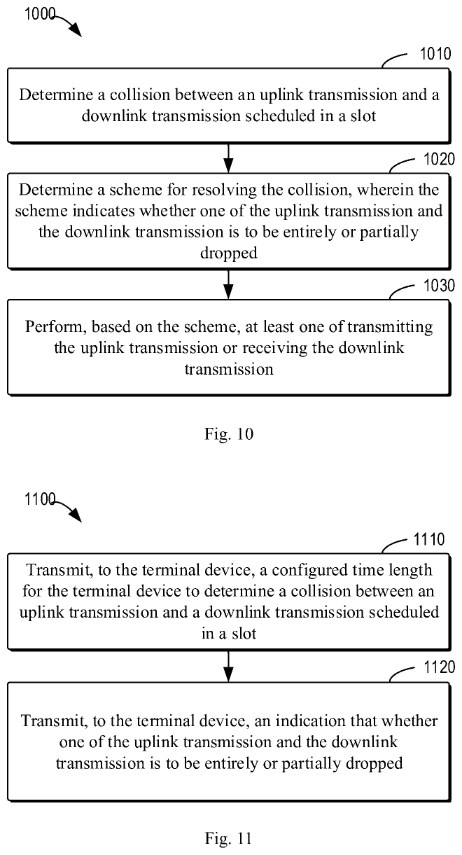

FIG. 10 illustrates a schematic diagram illustrating a method 1000 implemented at a terminal device 110 according to some embodiments of the present disclosure. As shown in FIG. 10, at block 1010, the terminal device 110 may determine a collision between an uplink transmission and a downlink transmission scheduled in a slot. At block 1020, the terminal device 110 may determine a scheme for resolving the collision, in which the scheme indicates whether one of the uplink transmission and the downlink transmission is to be entirely or partially dropped. At block 1030, the terminal device 110 may perform, based on the scheme, at least one of transmitting the uplink transmission or receiving the downlink transmission.

In some embodiments, in order to determine the collision, the terminal device 110 may determine that the uplink transmission starts later than a last symbol of the downlink transmission but earlier than an end of the configured time length starting from the last symbol of the downlink transmission. Additionally, or alternatively, the terminal device 110 may determine that the uplink transmission and the downlink transmission have at least one overlapping symbol. Additionally, or alternatively, the terminal device 110 may determine that the downlink transmission starts later than a last symbol of the uplink transmission but earlier than an end a second configured time length starting from the last symbol of the uplink transmission.

In some embodiments, the first configured time length or the second configured time length or both of them may be a hardcoded value stored in the terminal device 110 or indicated by a network device 120.

In some embodiments, the terminal device 110 may receive, from the network device 120, a first indication that priority information for an uplink resource corresponding to the downlink transmission indicates a priority of the downlink transmission.

In some embodiments, the priority information for the uplink resource may be first priority information. In order to determine the scheme for resolving the collision, the terminal device 110 may be based on second priority information for the uplink transmission and the first priority information, determine that priorities of the uplink transmission and the downlink transmission are the same, and determine the scheme for resolving the collision based on a second indication indicating whether one of the uplink transmission and the downlink transmission is to be entirely or partially dropped.

In some embodiments, the terminal device 110 may receive the second indication from the network device 120.

In some embodiments, the second indication may be comprised in scheduling information for scheduling the downlink transmission, additionally, or alternatively, the second indication may be comprised in a radio resource control (RRC) signaling.

In some embodiments, the second indication may be hardcoded information in the terminal device 110.

In some embodiments, the second indication may comprise: a set of starting symbols of the downlink transmission in a slot corresponding to an option of partially dropping or entirely dropping of the downlink transmission, additionally, or alternatively, a set of resource blocks of the downlink transmission in frequency domain corresponding to an option of the partially dropping or the entirely dropping, additionally, or alternatively, a length of the partial dropping, additionally, or alternatively, a plurality of options of length of the partial dropping and information for selecting one of the plurality of options.

In some embodiments, the second indication is indicative of: the downlink transmission is to be entirely dropped, additionally, or alternatively, the uplink transmission is to be entirely dropped in the event that there is no data to transmit in the uplink transmission or in case of negative scheduling request, additionally, or alternatively, the uplink transmission is to be entirely dropped, additionally, or alternatively, the downlink transmission is to be partially dropped.

In some embodiments, the second indication uses at least one of a time domain resource allocation (TDRA), a modulation and coding scheme (MCS) or a frequency domain resource allocation (FDRA) to indicate: a priority of the downlink transmission with respect to overlapping UL transmission, additionally, or alternatively, entirely dropping of the uplink transmission, additionally, or alternatively, partially dropping of the downlink transmission, additionally, or alternatively, entirely dropping of the downlink transmission.

In some embodiments, the scheme for resolving the collision may comprise: based on the second indication that the downlink transmission is to be partially dropped, determining a starting symbol from which the downlink transmission is to be partially dropped based on the first configured time length; and in the event that a condition to partially drop the downlink transmission is satisfied, partially dropping the downlink transmission starting from the starting symbol.

In some embodiments, the starting symbol may be at the first configured time length duration before the starting of the uplink transmission.

In some embodiments, the scheme for resolving the collision may comprise: in the event that the condition to partially drop the downlink transmission is not satisfied, entirely dropping the downlink transmission.

In some embodiments, in order to determine that the condition is satisfied, the terminal device 110 may determine that the condition is satisfied in the event that the duration from the last symbol of scheduling information for scheduling the downlink transmission to the starting symbol is not less than a third configured time length.

In some embodiments, in order to determine that the condition is satisfied, the terminal device 110 may determine that the condition is satisfied in the event that the duration from the last symbol of scheduling information for scheduling the downlink transmission to the first symbol where the collision occurs is less than a third configured time length.

In some embodiments, the third configured time length may be a hardcoded value stored in the terminal device 110 or the third configured time length is indicated by a network device 120.

In some embodiments, the scheme for resolving the collision may comprise: entirely dropping the downlink transmission based on: the downlink transmission is to be partially dropped being not indicated, additionally, or alternatively, the downlink transmission is to be entirely dropped being indicated.

FIG. 11 illustrates a schematic diagram illustrating a method 1100 implemented at the network device 120 according to some embodiments of the present disclosure. As shown in FIG. 11, at block 1110, the network device 120 may transmit, to the terminal device 110, a configured time length for the terminal device 110 to determine a collision between an uplink transmission and a downlink transmission scheduled in a slot. At block 1120, the network device 120 may transmit, to the terminal device 110, an indication that whether one of the uplink transmission and the downlink transmission is to be entirely or partially dropped.

In some embodiments, the indication may be referred to as a second indication, and the network device 120 may transmit, to the terminal device 110, a first indication that priority information for an uplink resource corresponding to the downlink transmission indicates a priority of the downlink transmission.

In some embodiments, the indication is comprised in scheduling information for scheduling the downlink transmission, additionally, or alternatively, a radio resource control (RRC) signaling.

In some embodiments, the indication may comprise: a set of starting symbols of the downlink transmission in a slot corresponding to an option of partially dropping or entirely dropping of the downlink transmission, additionally, or alternatively, a set of resource blocks of the downlink transmission in frequency domain corresponding to an option of the partially dropping or the entirely dropping, additionally, or alternatively, a length of the partial dropping, additionally, or alternatively, a plurality of options of length of the partial dropping and selecting information for selecting one of the plurality of options.

In some embodiments, the indication is indicative of: the downlink transmission is to be entirely dropped, additionally, or alternatively, the uplink transmission is to be entirely dropped in the event that there is no data to transmit in the uplink transmission or in case of negative scheduling request, additionally, or alternatively, the uplink transmission is to be entirely dropped, additionally, or alternatively, the downlink transmission is to be partially dropped.

In some embodiments, the indication uses at least one of a time domain resource allocation (TDRA), a modulation and coding scheme (MCS) or a frequency domain resource allocation (FDRA) to indicate: a priority of the downlink transmission with respect to overlapping UL transmission, additionally, or alternatively, entirely dropping of the uplink transmission, additionally, or alternatively, partially dropping of the downlink transmission, additionally, or alternatively, entirely dropping of the downlink transmission.

In some embodiments, the configured time length may be a first configured time length starting from the last symbol of the downlink transmission. Alternatively, or additionally, the configured time length may be a second configured time length starting from the last symbol of the uplink transmission.

In some embodiments, the network device 120 may indicate a third configured time length for the terminal device 110 to determine a scheme for resolving the collision.

In some embodiments, an apparatus capable of performing any of the method 1000 (for example, the terminal device 110) may comprise means for performing the respective steps of the method 1000. The means may be implemented in any suitable form. For example, the means may be implemented in a circuitry or software module.

In some embodiments, the apparatus comprises means for determining a collision between an uplink transmission and a downlink transmission scheduled in a slot; means for determining a scheme for resolving the collision, in which the scheme indicates whether one of the uplink transmission and the downlink transmission is to be entirely or partially dropped; and means for performing, based on the scheme, at least one of transmitting the uplink transmission or receiving the downlink transmission.

In some embodiments, the means for determining the collision comprises means for determining that the uplink transmission starts later than a last symbol of the downlink transmission but earlier than an end of the configured time length starting from the last symbol of the downlink transmission, additionally, or alternatively, means for determining that the uplink transmission and the downlink transmission have at least one overlapping symbol, additionally, or alternatively, means for determining that the downlink transmission starts later than a last symbol of the uplink transmission but earlier than an end a second configured time length starting from the last symbol of the uplink transmission.

In some embodiments, in which the first configured time length or the second configured time length or both of them is a hardcoded value stored in the terminal device 110 or the configured time length is indicated by a network device 120.

In some embodiments, the apparatus further comprises means for receiving, from a network device 120, a first indication that priority information for an uplink resource corresponding to the downlink transmission indicates a priority of the downlink transmission.

In some embodiments, in which the priority information for the uplink resource is first priority information, and the means for determining the scheme for resolving the collision comprises means for based on second priority information for the uplink transmission and the first priority information, determining that priorities of the uplink transmission and the downlink transmission are the same; and means for determining the scheme for resolving the collision based on a second indication indicating whether one of the uplink transmission and the downlink transmission is to be entirely or partially dropped.

In some embodiments, in which the apparatus further comprises means for receiving the second indication from the network device 120.

In some embodiments, the second indication is comprised in at least one of the following: scheduling information for scheduling the downlink transmission; or a radio resource control (RRC) signaling.

In some embodiments, the second indication is hardcoded information in the terminal device 110.

In some embodiments, in which the second indication comprises at least one of the following: a set of starting symbols of the downlink transmission in a slot corresponding to an option of partially dropping or entirely dropping of the downlink transmission; a set of resource blocks of the downlink transmission in frequency domain corresponding to an option of the partially dropping or the entirely dropping; a length of the partial dropping; or a plurality of options of length of the partial dropping and information for selecting one of the plurality of options.

In some embodiments, in which the second indication is indicative of one of the following: the downlink transmission is to be entirely dropped; the uplink transmission is to be entirely dropped in the event that there is no data to transmit in the uplink transmission or in case of negative scheduling request; the uplink transmission is to be entirely dropped; or the downlink transmission is to be partially dropped.

In some embodiments, in which the second indication uses at least one of a time domain resource allocation (TDRA), a modulation and coding scheme (MCS) or a frequency domain resource allocation (FDRA) to indicate at least one of: a priority of the downlink transmission with respect to overlapping UL transmission; entirely dropping of the uplink transmission; partially dropping of the downlink transmission; or entirely dropping of the downlink transmission.

In some embodiments, in which the scheme for resolving the collision comprises: based on the second indication that the downlink transmission is to be partially dropped, determining a starting symbol from which the downlink transmission is to be partially dropped based on the first configured time length; and in the event that a condition to partially drop the downlink transmission is satisfied, partially dropping the downlink transmission starting from the starting symbol.

In some embodiments, in which the starting symbol is at the first configured time length duration before the starting of the uplink transmission.

In some embodiments, in which the scheme for resolving the collision comprises: in the event that the condition to partially drop the downlink transmission is not satisfied, entirely dropping the downlink transmission.

In some embodiments, in which the means for determining that the condition is satisfied comprises means for determining that the condition is satisfied in the event that the duration from the last symbol of scheduling information for scheduling the downlink transmission to the starting symbol is not less than a third configured time length.

In some embodiments, in which the means for determining that the condition is satisfied comprises means for determining that the condition is satisfied in the event that the duration from the last symbol of scheduling information for scheduling the downlink transmission to the first symbol where the collision occurs is less than a third configured time length.

In some embodiments, in which the third configured time length is a hardcoded value stored in the terminal device 110 or the third configured time length is indicated by a network device 120.

In some embodiments, in which the scheme for resolving the collision comprises: entirely dropping the downlink transmission based on at least one of the following: the downlink transmission is to be partially dropped being not indicated; or the downlink transmission is to be entirely dropped being indicated.

In some embodiments, the apparatus further comprises means for performing other steps in some embodiments of the method 1000. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1100 (for example, the network device 120) may comprise means for performing the respective steps of the method 1100. The means may be implemented in any suitable form. For example, the means may be implemented in a circuitry or software module.

In some embodiments, the apparatus comprises means for transmitting, to a terminal device 110, a time length for the terminal device 110 to determine a collision between an uplink transmission and a downlink transmission scheduled in a slot; and means for transmit, to the terminal device 110, an indication that whether one of the uplink transmission and the downlink transmission is to be entirely or partially dropped.

In some embodiments, in which the indication is a second indication, and the apparatus further comprises means for transmitting, to the terminal device 110, a first indication that priority information for an uplink resource corresponding to the downlink transmission indicates a priority of the downlink transmission.

In some embodiments, in which the indication is comprised in at least one of the following: scheduling information for scheduling the downlink transmission; or a radio resource control (RRC) signaling.

In some embodiments, in which the indication comprises at least one of the following: a set of starting symbols of the downlink transmission in a slot corresponding to an option of partially dropping or entirely dropping of the downlink transmission; a set of resource blocks of the downlink transmission in frequency domain corresponding to an option of the partially dropping or the entirely dropping; a length of the partial dropping; or a plurality of options of length of the partial dropping and selecting information for selecting one of the plurality of options.

In some embodiments, in which the indication is indicative of one of the following: the downlink transmission is to be entirely dropped; the uplink transmission is to be entirely dropped in the event that there is no data to transmit in the uplink transmission or in case of negative scheduling request; the uplink transmission is to be entirely dropped; or the downlink transmission is to be partially dropped.

In some embodiments, in which the indication uses at least one of a time domain resource allocation (TDRA), a modulation and coding scheme (MCS) or a frequency domain resource allocation (FDRA) to indicate at least one of: a priority of the downlink transmission with respect to overlapping UL transmission; entirely dropping of the uplink transmission; partially dropping of the downlink transmission; or entirely dropping of the downlink transmission.

In some embodiments, in which the configured time length is at least one of: a first configured time length starting from the last symbol of the downlink transmission; or a second configured time length starting from the last symbol of the uplink transmission.

In some embodiments, the apparatus further comprises means for indicating a third configured time length for the terminal device 110 to determine a scheme for resolving the collision.

In some embodiments, the apparatus further comprises means for performing other steps in some embodiments of the method 1100. In some embodiments, the means comprises at least one processor; and at least one memory including computer program code, the at least one memory and computer program code configured to, with the at least one processor, cause the performance of the apparatus.

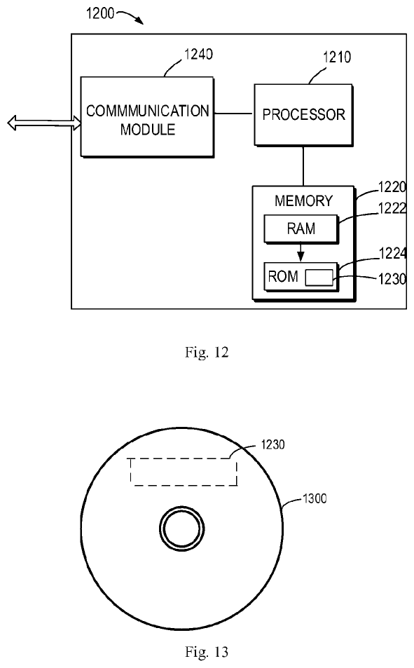

FIG. 12 is a simplified block diagram of a device 1200 that is suitable for implementing embodiments of the present disclosure. The device 1200 may be provided to implement the communication device, for example the terminal device 110, the network device 120 or the network device 120 as shown in FIG. 1A. As shown, the device 1200 includes one or more processors 1210, one or more memories 1220 coupled to the processor 1210, and one or more communication modules 1240 coupled to the processor 1210.

The communication modules 1240 is for bidirectional communications. The communication modules 1240 has at least one antenna to facilitate communication. The communication interface may represent any interface that is necessary for communication with other network elements.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1320. The processor 1210 may perform any suitable actions and processing by loading the program 1230 into the RAM 1320.

The embodiments of the present disclosure may be implemented by means of the program 1230 so that the device 1200 may perform any process of the disclosure as discussed with reference to FIGS. 2 to 11. The embodiments of the present disclosure may also be implemented by hardware or by a combination of software and hardware.

In some embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. The computer readable medium may include any types of tangible non-volatile storage, such as ROM, EPROM, a flash memory, a hard disk, CD, DVD, and the like. FIG. 13 shows an example of the computer readable medium 1300 in form of CD or DVD. The computer readable medium has the program 1230 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1000 or the method 1100 as described above with reference to FIGS. 2-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A terminal device comprising:
at least one processor; and
at least one memory storing instructions that, when executed by the at least one processor, cause the terminal device at least to:
determine a collision between an uplink transmission and a downlink transmission scheduled in a slot;
determine a scheme for resolving the collision, wherein the scheme indicates whether one of the uplink transmission and the downlink transmission is to be entirely or partially dropped; and
perform, based on the scheme, at least one of transmitting the uplink transmission or receiving the downlink transmission.

33. The terminal device of claim 32, wherein the terminal device is caused to determine the collision by at least one of the following:
determining that the uplink transmission starts later than a last symbol of the downlink transmission but earlier than an end of a first configured time length starting from the last symbol of the downlink transmission;
determining that the downlink transmission starts later than a last symbol of the uplink transmission but earlier than an end a second configured time length starting from the last symbol of the uplink transmission; or determining that the uplink transmission and the downlink transmission have at least one overlapping symbol.

34. The terminal device of claim 32, wherein the terminal device is caused to determine the collision by at least one of the following:
determining that the uplink transmission starts later than a last symbol of the downlink transmission but earlier than an end of a first configured time length starting from the last symbol of the downlink transmission;
determining that the downlink transmission starts later than a last symbol of the uplink transmission but earlier than an end a second configured time length starting from the last symbol of the uplink transmission; or determining that the uplink transmission and the downlink transmission have at least one overlapping symbol, and wherein at least one of the first configured time length or the second configured time length is at least one of:
a hardcoded value stored in the terminal device; or
indicated by a network device.

35. The terminal device of claim 32, wherein the terminal device is further caused to:
receive, from a network device, a first indication that priority information for an uplink resource corresponding to the downlink transmission indicates a priority of the downlink transmission.

36. The terminal device of claim 32, wherein the terminal device is further caused to:
receive, from a network device, a first indication that priority information for an uplink resource corresponding to the downlink transmission indicates a priority of the downlink transmission, and wherein the priority information for the uplink resource is first priority information, and the terminal device is caused to determine the scheme for resolving the collision by:
based on second priority information for the uplink transmission and the first priority information, determine that priorities of the uplink transmission and the downlink transmission are the same; and
determine the scheme for resolving the collision based on a second indication indicating whether one of the uplink transmission and the downlink transmission is to be entirely or partially dropped.

37. The terminal device of claim 32, wherein the terminal device is further caused to:
receive, from a network device, a first indication that priority information for an uplink resource corresponding to the downlink transmission indicates a priority of the downlink transmission, and wherein the priority information for the uplink resource is first priority information, and the terminal device is caused to determine the scheme for resolving the collision by:
based on second priority information for the uplink transmission and the first priority information, determine that priorities of the uplink transmission and the downlink transmission are the same; and
determine the scheme for resolving the collision based on a second indication indicating whether one of the uplink transmission and the downlink transmission is to be entirely or partially dropped, and wherein the second indication comprises at least one of the following:
a set of starting symbols of the downlink transmission in a slot corresponding to an option of partially dropping or entirely dropping of the downlink transmission;
a set of resource blocks of the downlink transmission in frequency domain corresponding to an option of the partially dropping or the entirely dropping;
a length of the partial dropping; or
a plurality of options of length of the partial dropping and information for selecting one of the plurality of options.

38. The terminal device of claim 32, wherein the terminal device is further caused to:
receive, from a network device, a first indication that priority information for an uplink resource corresponding to the downlink transmission indicates a priority of the downlink transmission, and wherein the priority information for the uplink resource is first priority information, and the terminal device is caused to determine the scheme for resolving the collision by:
based on second priority information for the uplink transmission and the first priority information, determine that priorities of the uplink transmission and the downlink transmission are the same; and
determine the scheme for resolving the collision based on a second indication indicating whether one of the uplink transmission and the downlink transmission is to be entirely or partially dropped, and wherein the second indication is indicative of one of the following:
the downlink transmission is to be entirely dropped;
the uplink transmission is to be entirely dropped in the event that there is no data to transmit in the uplink transmission or in case of negative scheduling request;
the uplink transmission is to be entirely dropped; or
the downlink transmission is to be partially dropped.

39. The terminal device of claim 32, wherein the terminal device is further caused to:
receive, from a network device, a first indication that priority information for an uplink resource corresponding to the downlink transmission indicates a priority of the downlink transmission, and wherein the priority information for the uplink resource is first priority information, and the terminal device is caused to determine the scheme for resolving the collision by:
based on second priority information for the uplink transmission and the first priority information, determine that priorities of the uplink transmission and the downlink transmission are the same; and
determine the scheme for resolving the collision based on a second indication indicating whether one of the uplink transmission and the downlink transmission is to be entirely or partially dropped, and wherein the second indication uses at least one of a time domain resource allocation (TDRA), a modulation and coding scheme (MCS), a RNTI, or a frequency domain resource allocation (FDRA) to indicate at least one of:
a priority of the downlink transmission with respect to overlapping UL transmission;
entirely dropping of the uplink transmission;
partially dropping of the downlink transmission; or
entirely dropping of the downlink transmission.

40. The terminal device of claim 32, wherein the terminal device is further caused to:
receive, from a network device, a first indication that priority information for an uplink resource corresponding to the downlink transmission indicates a priority of the downlink transmission, and wherein the priority information for the uplink resource is first priority information, and the terminal device is caused to determine the scheme for resolving the collision by:
based on second priority information for the uplink transmission and the first priority information, determine that priorities of the uplink transmission and the downlink transmission are the same; and
determine the scheme for resolving the collision based on a second indication indicating whether one of the uplink transmission and the downlink transmission is to be entirely or partially dropped, and wherein the scheme for resolving the collision comprises:
based on the second indication that the downlink transmission is to be partially dropped, determining a starting symbol from which the downlink transmission is to be partially dropped based on a first configured time length starting from the last symbol of the downlink transmission; and
in the event that a condition to partially drop the downlink transmission is satisfied, partially dropping the downlink transmission starting from the starting symbol.

41. The terminal device of claim 32, wherein the terminal device is further caused to:
receive, from a network device, a first indication that priority information for an uplink resource corresponding to the downlink transmission indicates a priority of the downlink transmission, and wherein the priority information for the uplink resource is first priority information, and the terminal device is caused to determine the scheme for resolving the collision by:
based on second priority information for the uplink transmission and the first priority information, determine that priorities of the uplink transmission and the downlink transmission are the same; and
determine the scheme for resolving the collision based on a second indication indicating whether one of the uplink transmission and the downlink transmission is to be entirely or partially dropped, and wherein the scheme for resolving the collision comprises:
entirely dropping the downlink transmission based on at least one of the following:
the downlink transmission is to be partially dropped being not indicated; or
the downlink transmission is to be entirely dropped being indicated.

42. A network device comprising:
at least one processor; and
at least one memory storing instructions that, when executed by the at least one processor, cause the network device at least to:
transmit, to a terminal device, a configured time length for the terminal device to determine a collision between an uplink transmission and a downlink transmission scheduled in a slot; and
transmit, to the terminal device, an indication that whether one of the uplink transmission and the downlink transmission is to be entirely or partially dropped.

43. The network device of claim 42, wherein the indication is a second indication, and the network device is further caused to:
transmit, to the terminal device, a first indication that priority information for an uplink resource corresponding to the downlink transmission indicates a priority of the downlink transmission.

44. The network device of claim 42, wherein the indication is comprised in at least one of the following:
scheduling information for scheduling the downlink transmission; or
a radio resource control (RRC) signaling.

45. The network device of claim 42, wherein the indication comprises at least one of the following:
a set of starting symbols of the downlink transmission in a slot corresponding to an option of partially dropping or entirely dropping of the downlink transmission;
a set of resource blocks of the downlink transmission in frequency domain corresponding to an option of the partially dropping or the entirely dropping;
a length of the partial dropping; or
a plurality of options of length of the partial dropping and selecting information for selecting one of the plurality of options.

46. The network device of claim 42, wherein the indication is indicative of one of the following:
the downlink transmission is to be entirely dropped;
the uplink transmission is to be entirely dropped in the event that there is no data to transmit in the uplink transmission or in case of negative scheduling request;
the uplink transmission is to be entirely dropped; or
the downlink transmission is to be partially dropped.

47. The network device of claim 42, wherein the indication uses at least one of a time domain resource allocation (TDRA), a modulation and coding scheme (MCS) or a frequency domain resource allocation (FDRA) to indicate at least one of:
a priority of the downlink transmission with respect to overlapping UL transmission;
entirely dropping of the uplink transmission;
partially dropping of the downlink transmission; or
entirely dropping of the downlink transmission.

48. The network device of claim 42, wherein the configured time length is at least one of:
a first configured time length starting from the last symbol of the downlink transmission; or
a second configured time length starting from the last symbol of the uplink transmission.

49. The network device of claim 42, wherein the network device is further caused to:
indicate a third configured time length for the terminal device to determine a scheme for resolving the collision.
